(19) United States
(12) Patent Application Publication
(10) Pub. No.: US 2009/0271859 A1
(43) Pub. Date: Oct. 29, 2009

(54) SYSTEMS AND METHODS FOR RESTRICTING EVENT SUBSCRIPTIONS THROUGH PROXY-BASED FILTERING

(75) Inventor: Dirk Trossen, Cambridge, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/494,657

(22) Filed: Jun. 30, 2009

Related U.S. Application Data
(63) Continuation of application No. 10/601,805, filed on Jun. 23, 2003.

(51) Int. Cl. H04L 9/32

(52) U.S. Cl. 726/12

(57) ABSTRACT

A system, method and filter are provided for restricting event subscriptions. The system includes an event server, such as a session initiation protocol (SIP) event server, capable of maintaining at least one event. Also, the system includes a network entity, such as a requester, capable of sending a subscription message, such as a SIP SUBSCRIBE message, subscribing to the event. Further, the system includes a proxy, such as an SIP proxy, associated with the event server, and in coupled between the event server and the network entity. In this regard, the proxy is capable of receiving the subscription message. The system also includes a filter capable of receiving the subscription message from the proxy. Thereafter, the filter can determine whether the network entity is an authorized subscriber. Then, if the network entity is an authorized subscriber, the proxy can forward the subscription message to the event server.

### CROSS-REFERENCE TO RELATED APPLICATION

The present application is a continuation of U.S. patent application Ser. No. 10/601,805 filed on Jun. 23, 2003, the content of which is incorporated herein by reference in its entirety.

### FIELD OF THE INVENTION

The present invention relates generally to telecommunications networks and, more particularly, relates to systems and methods for restricting event subscriptions, such as Session Initiation Protocol (SIP) SUBSCRIBE messages, through proxy-based filtering.

### BACKGROUND OF THE INVENTION

So-called unsolicited requests pose an increasing problem to the current communication infrastructure since such requests enable Denial-Of-Service (DoS) attacks to end systems that receive those requests. For instance, flooding port 8080 on a computer by sending Hypertext Transfer Protocol (HTTP) requests (without the intention on the side of the “attacker” to actually invoke an HTTP session) to the computer in large numbers can often slow down the computer, and can also increase the network load on the computer.

In mobile systems, the problem of unsolicited requests becomes even more of a problem. In this regard, every unsolicited request that is not desired by the mobile terminal is transmitted over the wireless link, most likely at the cost of the user (in a volume-based system). Additionally, central processing unit (CPU) and memory consumption of the mobile terminal increases due to the reception of such packets, draining the battery of the mobile terminal for packets that are actually not desired. For these reasons, most mobile operators block unsolicited requests to mobile terminals.

The consequences of such blocking, however, are the drawbacks of the intended protection of the user. For instance, establishing a Web service provider on a mobile terminal typically requires the mobile terminal to be capable of receiving unsolicited requests, such as HTTP requests on port 8080. Since these requests are typically blocked as unsolicited requests, such services cannot be established on the mobile terminal.

As will be appreciated by those skilled in the art, the problem of unsolicited requests is not solved by simply authenticating the calling party, such as through Session Initiation Protocol (SIP) authentication methods. Instead, the problem relates to authorizing the service transaction. In this regard, although a calling party may be authorized to access network and operator resources, service transactions with the called party are not necessarily desired and authorized. Currently, several techniques are being developed to cope with the blocking of unsolicited requests that are actually not malicious.

One technique to cope with the blocking of unsolicited, but non-malicious requests, utilizes SIP to establish a pull session for information retrieval. In this regard, calling models such as SIP provide an application layer signaling protocol related to multimedia sessions (see, e.g., IETF request for comment document RFC 3261, entitled: SIP: Session Initiation Protocol, July 2002, the contents of which are hereby incorporated by reference in its entirety). SIP was generally developed to allow for initiating a session between two or more endpoints in the Internet by making these endpoints aware of the session semantics. Accordingly, devices (or users that run certain applications on these devices) are registered with the SIP backbone so that an invitation to a particular session, such as via an INVITE message, can be correctly delivered to these endpoints. To achieve this, SIP provides a registration mechanism for devices and users, and it applies mechanisms such as location servers and registrars to route the session invitations appropriately.

To utilize SIP according to one conventional technique of coping with the blocking of unsolicited, but non-malicious requests, a session may be established through the SIP INVITE techniques or through dedicated SIP techniques to initiate a pull of transaction information from the client to the server (e.g., the mobile terminal). Such a technique relies on the assumption that these SIP techniques for initiating a pull of transaction information are not typically blocked by the operators. However, such an assumption can be proven wrong in the following sense: although the design of SIP (and the usage of INVITE) allows for establishing any type of session, the use of SIP has traditionally been limited to merely establishing some type of call-based transaction, mostly a Voice over IP (VoIP) call. And this type of “call” service requires a passthrough of invitation requests since conventional phone operation typically allows most calls and blocks few selected calls. On the other hand, for service initiations carried “in-band” of the session, a passthrough is desired only for dedicated callers (defined by the callee), and blocked for all other callers. Providing a passthrough for service initiations “in-band” for most calls while blocking only a select few, however, can lead to the same problem of unsolicited request DoS attacks, as described above.

Conventional techniques utilizing SIP therefore require selective passthrough of only certain INVITE messages. However, in order to perform such selective passthrough of INVITE messages, the type of transaction or service typically must be known. For example, the system can be configured to pass INVITE messages that initiate a phone call (except for some blocked numbers), while blocking mobile web service transactions except for those the mobile user actually initiates (in order to avoid abovementioned unsolicited request DoS attacks). To implement such a system configuration, however, the SIP proxy handling the SIP INVITE message on the callee side requires additional logic. To operate, then, such logic must be capable of examining the described service transaction in the INVITE message to perform the dedicated blocking policies, which are most likely different and dedicated for each service. Although such examination techniques are feasible, they are undesirable for several reasons. Due to the necessary additional functionality, and the most likely addition of an application server to perform the examination, such techniques undesirably increase the delay for a session setup, and the load on the SIP proxy is undesirably increased due to the additional required operations. In this regard, it is often desirable to minimize the basic session setup operation utilizing INVITE messages, which is in contradiction to the insertion of such kind of additional examination logic.

### SUMMARY OF THE INVENTION

In light of the foregoing background, embodiments of the present invention provide systems, methods and filters for restricting event subscriptions through proxy-based filtering. Embodiments of the present invention enable blocking unsolicited event subscriptions, such as SIP event subscriptions. Advantageously, embodiments of the present invention enable the establishment of SIP event-based services on service/content providers, for example, without exposing the service/content providers to any type of unwanted request. Also, embodiments of the present invention enable requester(s) to subscribe to events in a restricted manner, where the restrictions are implemented in a manner transparent to the requester(s).

Embodiments of the present invention can be implemented by callees, such as event servers, with the callees only specifying a list of authorized subscribers. Additionally, embodiments of the present invention can determine whether to block subscriptions based upon uniform resource identifiers (URIs) of network entities sending subscription messages, and possibly other information, all of which may be specified in header fields of subscription messages. In this regard, complex payload examination is typically not necessary. Embodiments of the present invention therefore provide higher security to such service/content providers, while exposing the system to reduced communication bandwidth consumption, which may lead to lower costs for users in volume-based charging systems, and less drainage of battery power due to reduced reception of unwanted packets.

According to one aspect of the present invention, a system is provided for restricting event subscriptions. The system includes an event server, such as a session initiation protocol (SIP) event server, capable of maintaining at least one event. Also, the system includes a network entity, such as a requester, capable of sending a subscription message, such as a SIP SUBSCRIBE message, subscribing to the event. In this regard, the subscription message can include an event package description and/or an event type description. Further, the system includes a proxy, such as an SIP proxy, associated with the event server, and coupled between the event server and the network entity.

The proxy is capable of receiving the subscription message. And in accordance with embodiments of the present invention, the system also includes a filter capable of receiving the subscription message from the proxy. Thereafter, the filter can determine whether the network entity is an authorized subscriber. Then, if the network entity is an authorized subscriber, the proxy can forward the subscription message to the event server. Upon receipt of the subscription message, the event server can be capable of confirming reception of the subscription message, where the event server receives the subscription message if a match is located and the proxy forwards the subscription message to the event server.

The filter can be capable of storing a list of authorized subscribers, which the event server can send before the proxy receives the subscription message. The list of authorized subscribers identifies the event server and at least one authorized subscriber. In this regard, each authorized subscriber can be identified by a URI associated with the respective authorized subscriber, an event package description associated with a subscription message, and/or an event type description associated with a subscription message. With the list of authorized subscribers, the filter can be capable of determining whether the network entity is an authorized subscriber by checking for a match of the network entity in the list of authorized subscribers. Then, if a match is located, the proxy can forward the subscription message to the event server.

More particularly, the filter can be capable of checking for a match of a URI associated with the network entity with at least a partial URI in the list of authorized subscribers. Additionally, the filter can be capable of checking for a match by further checking for a match of the event package description and/or the event type description in the subscription message with an event package description and/or an event type description associated with the URI in the list of authorized subscribers.

According to other aspects of the present invention, a method and filter for restricting event subscriptions are provided. Embodiments of the present invention therefore provide systems, methods and filters for restricting event subscriptions through proxy-based filtering. Embodiments of the present invention enable blocking unsolicited event subscriptions, such as SIP event subscriptions, where unsolicited event subscriptions are subscriptions other than those from authorized subscribers, as expressed in a list of authorized subscribers. In this regard, embodiments of the present invention can determine whether to block subscriptions based upon URIs of network entities sending subscription messages, and other information such as an event package description and/or an event type description. Embodiments of the present invention therefore provide higher security to subscriptions from unauthorized subscribers, while exposing the system to reduced communication bandwidth consumption. In turn, reduced bandwidth consumption may lead to lower costs for users in volume-based charging systems, and less drainage of battery power due to reduced reception of unwanted packets. Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 shows a system for restricting event subscriptions through proxy-based filtering, according to one embodiment of the present invention;

FIG. 2 is a schematic block diagram of a mobile station that may act as either a requester or a SIP Event Server, according to embodiments of the present invention;

FIG. 3 is a schematic block diagram of a server, which may be representative of a requester, a SIP event server, or a filter, according to one embodiment of the present invention; and

FIG. 4 shows message flows between entities of the system operating in accordance with one embodiment of a method for restricting event subscriptions through proxy-based filtering.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

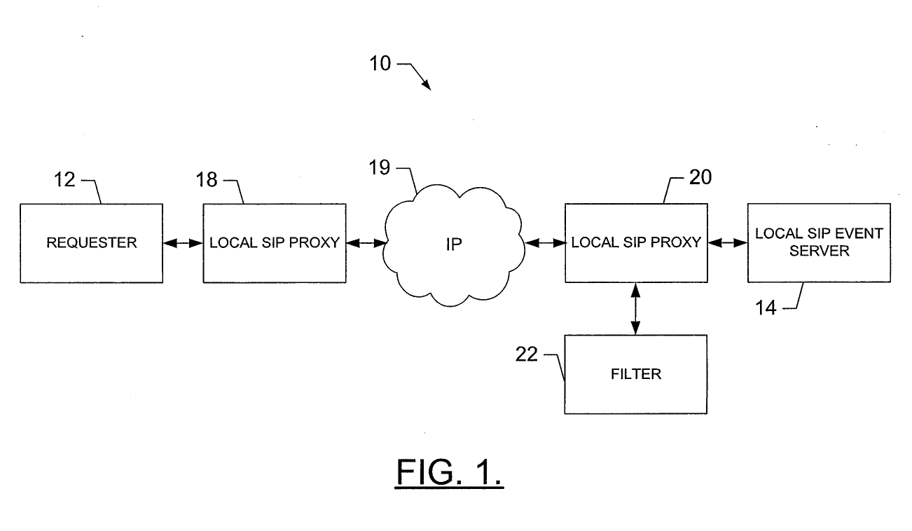

Referring now to FIG. 1, a general system 10 is shown that supports restricting event subscriptions through proxy-based filtering, according to embodiments of the present invention. The system generally includes a requester 12, a SIP event server 14, and an IP communications network 19 through which the SIP event server and the requester communicate. In accordance with embodiments of the present invention, the system 10 provides a session initiation protocol (SIP) framework. As such, the requester and SIP event server are each registered with a corresponding local SIP proxy 18 and 20, respectively. Further, the system includes a filter 22, which is typically coupled to the local SIP proxy 20 of the SIP event server.

The requester 12 may be any device or entity capable of subscribing to an SIP event. The SIP event server 14 may be any device or entity capable of implementing SIP events and maintaining subscriptions to such SIP events. The filter 22 may be any device or entity capable of operating in accordance with embodiments of the present invention, as described below. Generally, however, the filter may be any device or entity capable of determining whether or not to block a SIP event subscription request from requester(s), such as requester 12, to the SIP event server 14. The filter can determine whether to block the SIP event subscription request according to any of a number of different techniques. According to one advantageous technique, the filter maintains a list of authorized subscribers such that when a requester attempts to subscribe to an event, the filter determines whether the requester is an authorized subscriber. If the requester is an authorized subscriber, the filter permits the subscription request to proceed to the SIP event server. But if the requester is not an authorized subscriber, the filter prevents the subscription request from proceeding to the SIP event server.

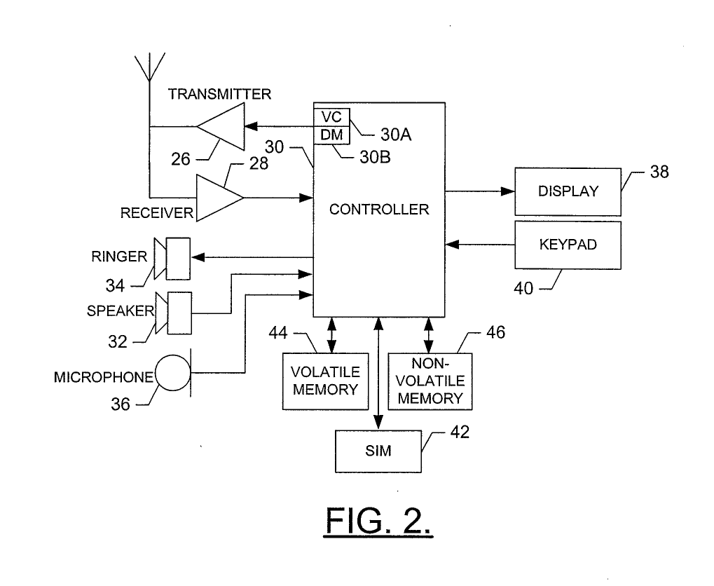

Referring now to FIG. 2, a functional diagram of a mobile station is shown that may act as either a requester 12 or a SIP Event Server 14, according to embodiments of the invention. It should be understood that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 26, a receiver 28, and a controller 30 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1 G), second-generation (2 G), 2.5 G and/or third-generation (3 G) communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 30A, and may include an internal data modem (DM) 30B. Further, the controller may include the functionally to operate one or more software programs, which may be stored in memory. For example, the controller may be capable of operating a connectivity program, such as a conventional Web browser. The connectivity program may then allow the mobile station to transmit and receive Web content, such as according to the Wireless Application Protocol (WAP), for example.

The mobile station also comprises a user interface including a conventional earphone or speaker 32, a ringer 34, a microphone 36, a display 38, and a user input interface, all of which are coupled to the controller 30. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 42, a removable user identity module (R-UIM) or the like, which typically stores information elements related to a mobile subscriber. In addition to the SIM, the mobile station can include other memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can store an identifier, such as an international mobile equipment identification (IMEI) code, capable of uniquely identifying the mobile station, such as to a mobile switching center (MSC). Also, for example, the memories can store instructions for creating messages related to embodiments of the present invention, such as SUBSCRIBE messages, as described below.

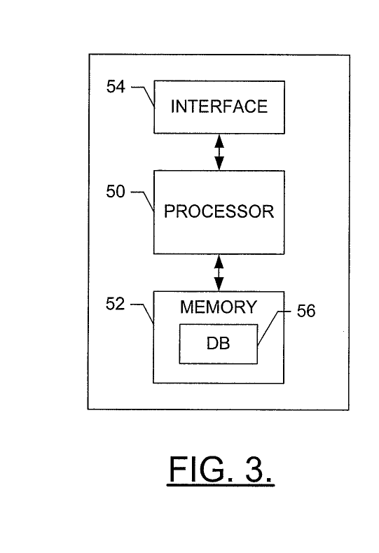

Referring now to FIG. 3, a block diagram of an entity that may act as a requester 12, a SIP event server 14, or a filter 22 is shown. The entity acting as either the requester, the SIP event server, or the filter agent generally includes a processor 50 connected to a memory 52 and an interface 54. The memory typically includes instructions for the processor to perform steps associated with operation of the respective element in accordance with embodiments of the present invention. Further, as a SIP event server, the memory may store a local database (DB) 56 containing subscription information for devices or uniform resource identifiers (URIs).

Additionally, as a filter 22, the memory may store a local database containing a list of authorized subscribers, where the authorized subscribers may be identified in any of a number of different manners. For example, the authorized subscribers may be identified by at least a partial URI associated with the respective authorized subscribers. In this regard, one or more authorized subscribers may be identified by a partial URI, such as by including one or more wildcard terms within the URI. For example, an authorized subscriber may be identified by the URI “sip:requester@domain.com,” where the URI uniquely identifies the authorized subscriber, “requester.” Also, for example, one or more authorized subscribers may be identified by the partial URI “sip:*@domain.com,” where the asterisk (*) is interpreted as a wildcard such that the URI uniquely identifies one or more requesters within the domain “domain.”

In addition to being identified by at least a partial URI, one or more authorized subscribers may be identified based upon other information, such as a predefined event package and/or a predefined event type. By identifying one or more authorized subscribers by at least a partial URI as well as other information, the filter 22 can restrict authorized subscribers to those requesters 12 associated with a particular URI and the other information, such as by restricting authorized subscribers to those including the URI and attempting to subscribe to the predefined event package and/or a predefined event type. The identifications of the authorized subscribers can be formulated in any of a number of different formats, such as in Resource Description Framework (RDF), Extensible Markup Language (XML) and/or attribute-value pairs.

As indicated above, in accordance with embodiments of the present invention, the system 10 provides a session initiation protocol (SIP) framework, with the requester 12 and the SIP event server 14 each registered with a corresponding local SIP proxy 18 and 20, respectively. Although shown as separate logical entities, the requester and SIP proxy 18 may be co-located. Likewise, the SIP event server and SIP proxy 20 may be co-located. It should be understood, however, that the SIP event server is generally an entity that is logically separate from SIP proxy 20. It should also be understood that the filter 22 may be co-located with SIP proxy 20, and by extension, may be co-located with the SIP event server. Based on the system, then, methods of restricting event subscriptions through proxy-based filtering according to embodiments of the present invention may be practiced.

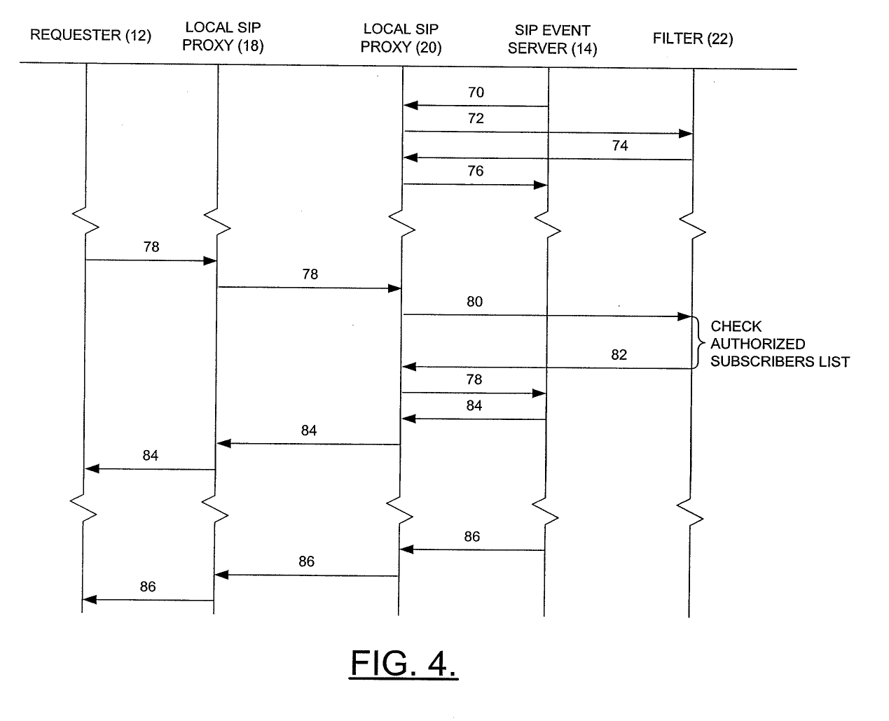

Using the system 10 as an example framework, a method for restricting event subscriptions through proxy-based filtering according to one embodiment of the invention will be described below. Referring now to FIG. 4 in particular, as well as FIGS. 1-3 in general, message flows for a method of restricting event subscriptions according to one embodiment of the present invention are shown. According to one embodiment, the method generally includes providing a list of authorized subscribers to the filter 22, where the list of authorized subscribers can identify the authorized subscribers in any of a number of different manners, such as those described above. In this regard, as shown in accordance with one embodiment of the present invention, the list of authorized subscribers can be provided to the filter by first providing the list of authorized subscribers to SIP proxy 20.

As shown, the list of authorized subscribers can be sent from the SIP event server 14 to SIP proxy 20 using a message 70 comprising, for example, a SIP REGISTER or SIP PUBLISH message, as such are well known to those skilled in the art. Upon reception of message 70, SIP proxy 20 can send the list of authorized subscribers to the filter 22, such as via message 72. The list of authorized subscribers can be sent to the filter in accordance with any of a number of different techniques, specifications, protocols or the like, such as in accordance with HTTP. Upon reception of the list of authorized subscribers, the filter stores the list, such as in database 56 stored in memory 52 (see FIG. 3). After receiving the list of authorized subscribers, the filter can, if so desired, send a confirmation back to SIP proxy 20, such as in a message 74. Thereafter, SIP proxy 20 can confirm storage of the list of authorized users by sending message 76 to the SIP event server. For example, SIP proxy 20 can confirm storage of the list by sending a SIP “200 OK” message to the SIP event server, particularly in instances in which the SIP event server sent the list to SIP proxy 20 in a SIP REGISTER or SIP PUBLISH message.

At some time after storing the list of authorized subscribers, one or more requesters, such as requester 12, may subscribe to notifications for particular events. By subscribing to notifications for particular events, the requester can receive notifications related to subscribed-to events at periodic intervals, such as at pre-defined intervals or when the status changes for subscribed-to events. To attempt to subscribe to a particular event, the requester can send a SUBSCRIBE message 78 to its corresponding local SIP proxy 18, which can include a payload comprising, for example, a description of desired content and/or service and the event of interest such as, for example, registered/published or de-registered. The SUBSCRIBE message also includes the URI of the SIP event server 14, such as in a TO field, and the URI of the requester, such as in a FROM field. The SUBSCRIBE message may further contain an “expires” parameter indicating duration of the subscription. Depending on the length of the subscription, the requester may receive periodic notifications in response to changes for the event or may receive a one-time notification of available color printers.

The SUBSCRIBE message 78 according to this embodiment may be a message that is part of an extension to SIP as defined in IETF's request for comment document RFC 3265, entitled: SIP-Specific Event Notification, dated June 2002, the contents of which are hereby incorporated by reference in its entirety. The SUBSCRIBE message is appropriately forwarded to SIP proxy 20 from SIP proxy 18. Upon reception of the SUBSCRIBE message at SIP proxy 20, the SUBSCRIBE message can be forwarded to the filter 22, such as within message 80. The SUBSCRIBE message can be forwarded to the filter according to any of a number of different techniques. For example, the message can be forwarded to the filter within an HTTP POST request or in accordance with the Simple Object Access Protocol (SOAP), as both are well known to those skilled in the art.

Upon reception of message 80, the filter 22 extracts the URIs in the TO and FROM fields of the SUBSCRIBE message, such as the URIs of the SIP event server 14 and the requester 12, respectively. By extracting the URIs, the filter can identify the callee and the caller for the respective SUBSCRIBE message. Also, depending upon how the authorized subscribers are identified (e.g., including other information), the filter may also extract other information from the SUBSCRIBE message, such as the event package and/or the event type. The filter can thereafter compare the URI (and possibly other information) for the requester, with the list of authorized subscribers for the callee (e.g., SIP event server). In this regard, as will be appreciated, the filter can store one or more lists of authorized subscribers for one or more callees, such as the SIP event server.

The filter 22 can compare the URI with the list of authorized subscribers for the callee (e.g., SIP event server 14) according to any of a number of different techniques. For example, the filter can retrieve the list of authorized subscribers, such as from the database 56 stored in memory 52. Thereafter, the filter can attempt to match the caller (e.g., requester 12), which may be identified based upon the URI of the caller and possibly other information, with one of the authorized subscribers in the list. More particularly, the filter can attempt to match the URI of the caller to a URI within the list of authorized subscribers, applying any appropriate wildcard terms, as described above. Additionally, if specified and if a URI match is found, the filter can further attempt to match other information identifying the authorized subscriber, such as the event package and/or event type specified in the SUBSCRIBE message 78.

After attempting to match the caller (e.g., requester 12) with an authorized subscriber in the list of authorized subscribers, the filter 22 can send a response message 82 back to SIP proxy 20 indicating whether the filter located a match. Like message 80, the response message 82 can be forwarded to SIP proxy 20 in accordance with any of a number of different techniques, such as within an HTTP POST request or in accordance with SOAP. If the filter located a match for the requester, SIP proxy 20 can forward the original SUBSCRIBE message 78 to the SIP event server 14 (i.e., callee). If the filter did not locate a match, however, SIP proxy 20 does not forward the SUBSCRIBE message to the SIP event server. In this regard, although not shown, SIP proxy 20 can notify the requester that the SUBSCRIBE message has been blocked from the SIP event server, such as by sending an appropriate SIP error code to the requester via SIP proxy 18.

Upon reception of the SUBSCRIBE message 78, presuming a match of the requester 18 with an authorized subscriber, the SIP event server 14 can store the subscription for the specified event (e.g., published/registered, de-registered) in the local database 56 stored in memory 52 (shown in FIG. 3). The associated description and the expiration time for the subscription are also stored in the local database. Upon reception of the SUBSCRIBE message, the SIP event server can appropriately confirm reception with a ‘200 OK’ message 84 sent to the requester 18 via proxies 20 and 18.

After storing the subscription for the specified event, the SIP event server 14 and requester 12 can communicate in accordance with the subscription, such as independent of the filter 22. For example, presume that the requester has subscribed to notifications from the SIP event server regarding events associated with services and/or content available from one or more service/content providers that may be registered, or may subsequently register, with the SIP event server for providing service/content communications to requester(s). In such an instance, presuming that the requester 18 subscribed for a published/registered event, the SIP event server can perform a match with the service and/or content requested, such as in accordance with any of a number of different techniques. Then, the SIP event server can send a SIP NOTIFY message 86 back to the requester 18 via proxies 20 and 18, as such is well known to those skilled in the art.

The NOTIFY message can contain the description of found services and/or content and the triggered event (e.g., registered/published) in an appropriate format. The NOTIFY message can further contain one or more contact URI(s) provided in the service registration(s) of the service/content provider(s). If the SIP event server did not find a match for the requested services/content, however, the payload of the NOTIFY message can contain an appropriate indication. Upon reception of NOTIFY message, the requester can extract the received service/content descriptions and the contact URI for further use, if available. For more information on various communications available between the requester and the SIP event server after the SIP event server stores the subscription, see U.S. patent application Ser. No. 10/330,146, entitled: Content and Service Registration, Query and Subscription, and Notification in Networks, filed Dec. 30, 2002, the contents of which are hereby incorporated by reference in its entirety.

It will be appreciated that one embodiment of the present invention allows for a one-time notification scheme, which may be referred to as a QUERY. For a QUERY, the requester 12 can send a SUBSCRIBE message 78 to subscribe to an event, such as a published/registered event, in which an expiration time of zero is specified for the subscription. In such an instance, in this embodiment, the filter 22 performs a matching of the requester with an authorized subscriber. However, presuming a match has been made with an authorized subscriber, the subscription is not stored in the local database 56 of the SIP event server 14. Thus, only the authorized subscriber matching, and service/content matching is performed, leading to an appropriate NOTIFY message (not shown) that is sent to requester 18 through SIP proxies 20, 18.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for restricting event subscriptions, wherein each event subscription subscribes to an event maintained by an event server, the method comprising:
receiving, at a proxy associated with the event server from a network entity, a subscription message subscribing to the event;
determining whether the network entity is an authorized subscriber; and
forwarding the subscription message to the event server if the network entity is an authorized subscriber, the network entity thereafter being capable of receiving communication from the event server in accordance with the subscription without again determining whether the network entity is an authorized subscriber.

2. A method according to claim 1, wherein determining whether the network entity is an authorized subscriber comprises checking for a match of the network entity in a list of authorized subscribers, and wherein forwarding the subscription message comprises forwarding the subscription message if a match is located.

3. A method according to claim 2, wherein checking for a match comprises checking for a match of a uniform resource identifier (URI) associated with the network entity with at least a partial URI in the list of authorized subscribers.

4. A method according to claim 3, wherein the subscription message includes at least one of an event package description or an event type description, and wherein checking for a match further comprises checking for a match of at least one of the at least one of the event package description or the event type description in the subscription message with at least one of an event package description or an event type description associated with the at least a partial URI in the list of authorized subscribers.

5. A method according to claim 1 further comprising sending a list of authorized subscribers to the proxy before receiving the subscription message, wherein the list of authorized subscribers identifies the event server and at least one authorized subscriber, and wherein at least one authorized subscriber is identified by at least one of a uniform resource identifier (URI) associated with the at least one authorized subscriber, an event package description associated with a subscription message, or an event type description associated with a subscription message.

6. A method according to claim 1 further comprising confirming reception of the subscription message, from the event server to the network entity, if a match is located and the subscription message is forwarded to the event server.

7. A method according to claim 1, wherein receiving a subscription message comprises receiving, at a session initiation protocol (SIP) proxy, a subscription message comprising a SIP SUBSCRIBE message, and wherein forwarding the subscription message comprises forwarding the SIP SUBSCRIBE message to the event server comprising a SIP event server.

8. A method according to claim 1, wherein determining whether the network entity is an authorized subscriber comprises determining, in response to receiving the subscription message, whether the network entity is an authorized subscriber for the respective event of the event server.

9. A system for restricting event subscriptions, the system comprising:
an event server configured to maintain at least one event;
a network entity configured to send a subscription message subscribing to the event;
a proxy associated with the event server, and coupled between the event server and the network entity, wherein the proxy is configured to receive the subscription message; and
a filter configured to receive the subscription message from the proxy, and thereafter determine whether the network entity is an authorized subscriber, wherein the proxy is configured to forward the subscription message to the event server if the network entity is an authorized subscriber, the network entity thereafter being capable of receiving communication from the event server in accordance with the subscription without the filter again determining whether the network entity is an authorized subscriber.

10. A system according to claim 9, wherein the filter is configured to store a list of authorized subscribers, wherein the filter is configured to determine whether the network entity is an authorized subscriber by checking for a match of the network entity in the list of authorized subscribers, and wherein the proxy is configured to forward the subscription message if a match is located.

11. A system according to claim 10, wherein the network entity has an associated uniform resource identifier (URI), and wherein the filter is configured to check for a match of the URI associated with the network entity with at least a partial URI in the list of authorized subscribers.

12. A system according to claim 11, wherein the subscription message includes at least one of an event package description or an event type description, and wherein the filter is configured to check for a match by further checking for a match of at least one of the at least one of the event package description or the event type description in the subscription message with at least one of an event package description or an event type description associated with the at least a partial URI in the list of authorized subscribers.

13. A system according to claim 9, wherein the event server is configured to send a list of authorized subscribers to the filter before the proxy receives the subscription message, wherein the list of authorized subscribers identifies the event server and at least one authorized subscriber, and wherein at least one authorized subscriber is identified by at least one of a uniform resource identifier (URI) associated with the at least one authorized subscriber, an event package description associated with a subscription message, or an event type description associated with a subscription message.

14. A system according to claim 9, wherein the event server is configured to confirm reception of the subscription message if a match is located and the proxy forwards the subscription message to the event server.

15. A system according to claim 9, wherein the event server comprises a session initiation protocol (SIP) server, wherein the proxy comprises a SIP proxy, and wherein the subscription message comprises a SIP SUBSCRIBE message.

16. An apparatus for restricting event subscriptions, wherein each event subscription subscribes to an event maintained by an event server, the apparatus comprising:
a processor configured to receive, from a proxy associated with the event server, a subscription message from a network entity subscribing to the event, wherein the processor is configured to determine whether the network entity is an authorized subscriber based upon a list of authorized subscribers stored in a database, and wherein the processor is configured to indicate to the proxy whether the network entity is an authorized subscriber such that the proxy can forward the subscription message to the event server if the network entity is an authorized subscriber, the network entity thereafter being capable of receiving communication from the event server in accordance with the subscription without the processor again determining whether the network entity is an authorized subscriber.

17. An apparatus according to claim 16, wherein the processor is configured to determine whether the network entity is an authorized subscriber by checking for a match of the network entity in a list of authorized subscribers, and wherein the processor is configured to indicate to the proxy whether the network entity is an authorized subscriber such that the proxy can forward the subscription message to the event server if a match is located.

18. An apparatus according to claim 17, wherein the processor is configured to check for a match of a uniform resource identifier (URI) associated with the network entity with at least a partial URI in the list of authorized subscribers.

19. An apparatus according to claim 16, wherein the subscription message includes at least one of an event package description or an event type description, and wherein the processor is configured to check for a match by further checking for a match of at least one of the at least one of the event package description or the event type description in the subscription message with at least one of an event package description or an event type description associated with the at least a partial URI in the list of authorized subscribers.

20. An apparatus according to claim 16, wherein the processor is configured to receive the list of authorized subscribers, and thereafter storing the list of authorized subscribers in the database, wherein the list of authorized subscribers identifies the event server and at least one authorized subscriber, and wherein at least one authorized subscriber is identified by at least one of a uniform resource identifier (URI) associated with the at least one authorized subscriber, an event package description associated with a subscription message, or an event type description associated with a subscription message.
